(19) United States
(12) Patent Application Publication
(10) Pub. No.: US 2023/0374841 A1
(43) Pub. Date: Nov. 23, 2023

(54) DRIVE DEVICE FOR MOVING A LEAF

(71) Applicant: dormakaba Deutschland GmbH, Ennepetal (DE)

(72) Inventors: Jan Eric VOM BROCKE, Ennepetal (DE); Sven BUSCH, Ennepetal (DE); Martin WAGNER, Ennepetal (DE)

(21) Appl. No.: 18/028,119

(22) PCT Filed: Sep. 24, 2021
(86) PCT No.: PCT/EP2021/076318

§ 371 Date: Mar. 23, 2023

(30) Foreign Application Priority Data
Sep. 25, 2020 (DE) 10 2020 125 117.3

(51) Int. Cl. E05F 15/63; H02K 3/26; H02K 7/116; H02K 21/24

(52) U.S. Cl. CPC E05F 15/63; H02K 3/26; H02K 7/116; H02K 21/24; E05Y 2201/438; E05Y 2201/442; E05Y 2201/474; E05Y 2201/716; E05Y 2201/72; E05Y 2900/132; E05Y 2800/236; E05Y 2900/148; H02K 2203/03

(57) ABSTRACT

A drive device for moving a leaf, in particular a door leaf or window leaf, includes an electric machine. The electric machine is an axial flux machine having a stator, in particular a single stator, and a rotor, in particular a single rotor, which is rotatable relative to the stator about a machine axis.

### CROSS-REFERENCE TO RELATED APPLICATIONS

This application is a 35 U.S.C. § 371 National Stage patent application of PCT/EP2021/076318 filed 24 Sep. 2021, which claims the benefit of German patent application 102020125117.3 filed 25 Sep. 2020, the disclosures of which are incorporated herein by reference in their entirety.

### TECHNICAL FIELD

The disclosure relates to a drive device for moving a leaf, in particular a door leaf or a window leaf, having the features of the preamble of claim 1.

### BACKGROUND

Drive devices can be used to move a leaf, with a leaf being understood in particular to mean a door or a window leaf. The movable part of a door is referred to as a door leaf, for which the term door panel is also common.

Such drive devices for moving a leaf are known.

Such drive devices are typically provided directly on the leaf to be moved or on a door frame or a window frame. The installation space available is very limited, in particular when assembling on the door frame or the window frame. In particular, however, a compact design of the drive device is also preferred when it is mounted on the leaf.

### SUMMARY

Against this background, the disclosure enables a compact configuration of the drive device.

This is achieved by providing a drive device having the features of claim 1. Advantageous further developments of the drive device are indicated in the dependent claims, the description and in the figures. Features and details that are described in connection with the drive device according to the disclosure also apply in connection with the method according to the disclosure and/or with the use according to the disclosure and vice versa. In this case, the features mentioned in the description and in the claims may each be essential to the disclosure individually by themselves or in combination. The description additionally characterizes and specifies the disclosure, in particular in connection with the figures.

A drive device for moving a leaf, in particular a door leaf or a window leaf, which has an electric machine, is particularly advantageously indicated. The electric machine is designed as an axial flux machine, comprising an, in particular single, stator and an, in particular single, rotor, which can be rotated about a machine axis with respect to the stator.

This configuration is advantageous in terms of a compact design combined with high performance. In addition, this configuration is advantageous in terms of the achievable saving in installation space.

The term axes, in particular as in the case of leaf axis, output axis, machine axis, axis of rotation, means virtual axes which are fundamentally not limited in their extent.

The machine axis means the axis of rotation about which the rotor of the electric machine rotates.

In the axial flux machine, the magnetic flux is mainly formed parallel to the machine axis of the electric machine. The axial flux machine has a small overall axial length compared to other machine types. The axial overall length means an overall length in a direction parallel to the machine axis. The use of an axial flux machine therefore enables the dimensions of the electric machine to be reduced in the axial direction. This allows a compact configuration of a drive module to be made possible. In particular, the axial flux machine can be a brushless direct current machine, in particular a so-called BLDC machine. Such a machine is designed like a three-phase synchronous machine with excitation by permanent magnets.

The axial flux machine can be designed as a motor and/or generator. As a motor, the axial flux machine can generate a rotational movement, in particular a torque, from electrical energy. As a generator, the axial flux machine can generate electrical energy from a rotational movement, in particular from a torque.

It may be preferred that the stator has 7 to 16, particularly preferably 10 to 14 coils, with the coil or coils of the stator being arranged in such manner that a magnetic flux can be generated through the coil or coils in a direction parallel to the machine axis.

The term coil means an electrical conductor with at least one winding. The electrical conductor can be designed as a wire and/or strip, in particular insulated by means of a coating, preferably by means of an insulating varnish. In particular, the coil can be designed as a cast coil, with individual windings of the coil being electrically insulated from one another by means of a cast material.

It may be preferred that the rotor comprises at least one permanent magnet, with the permanent magnet being arranged along a virtual circle around the machine axis and spanning a first angular range. It may also be preferred that the stator comprises a stator base with at least one stator tooth protruding from the stator base, in particular in the axial direction of the axial flux machine, with the stator tooth being arranged along a virtual circle around the machine axis and spanning a second angular range, with the ratio of the first angular range as a dividend to the second angular range being in the range from 1.1 to 1.6, preferably in the range from 1.2 to 1.5, particularly preferably in the range from 1.3 to 1.4. If there are a plurality of stator teeth and/or permanent magnets, each stator tooth can have the above-mentioned ratio to each permanent magnet. The stator tooth and the permanent magnet thereby span the respective angular range in that they are arranged along the respective virtual circle around the machine axis and extend over part of the 360° of the virtual circle.

Alternatively or cumulatively, in the case of a plurality of permanent magnets and/or stator teeth, the ratio of the first summed angular range as a dividend to the second summed angular range can be in a range from 1.3 to 1.9 or even from 1.5 to 1.8, with the first summed angular range being formed from the sum of the first angular ranges of the individual permanent magnets and the second summed angular range being formed from the sum of the second angular ranges of the individual stator teeth.

The term circle around the machine axis means that the machine axis forms the center of the circle.

In particular, a surface of the stator tooth, in particular of each stator tooth, running parallel to the stator base can be designed in such manner that the surface widens in the radial direction of the stator, starting from the machine axis. Alternatively or cumulatively, a surface of the permanent magnet, in particular of each permanent magnet, running parallel to the stator base can be designed in such manner that the surface widens in the radial direction of the rotor, starting from the machine axis. In this way, the specified ratio of the first angular range as a dividend to the second angular range can be kept constant along the radial profile of the stator. In particular, the surface of the stator tooth, in particular of each stator tooth, running parallel to the stator base can remain constant along the axial profile of the stator tooth.

In particular, at least one, in particular each, permanent magnet can be designed in the form of a plate. In particular, the rotor can have a rotor plate, in particular a rotor disc. Furthermore, at least one, in particular each, permanent magnet can protrude from the rotor plate of the rotor in the axial direction of the machine, in particular in the direction of the stator. In particular, the rotor plate can have one or a plurality of indentations, in particular a number of indentations corresponding to the number of permanent magnets, with a permanent magnet lying in each indentation. In particular, the shape of the indentation, in particular of each indentation, can correspond to the shape of the inlaid permanent magnet. This serves to secure the permanent magnets on the rotor, in particular on the rotor plate.

It may be preferred that the ratio between the number of permanent magnets as a dividend and the number of coils is in a range from 1.0 to 1.6, preferably in a range from 1.2 to 1.4, particularly preferably is 4:3, in particular is 1.1, in particular 7:6.

In particular, the electric machine, in particular as a motor, can have a ratio of the maximum torque to the axial extent of the machine that is greater than 30 Nm/m, preferably greater than 100 Nm/m, particularly preferably greater than 200 Nm/m. The axial extent is parallel to the machine axis. In particular, this ratio can be greater than 50 Nm/m, preferably greater than 70 Nm/m, particularly preferably greater than 150 Nm/m. In particular, the electric machine can have a torque density, i.e. torque to motor volume, of greater than or equal to 6000 Nm/m\hat{ }3, preferably greater than or equal to 15000 Nm/m\hat{ }3 and particularly preferably greater than or equal to 20000 Nm/m\hat{ }3 and/or a torque constant of greater than or equal to 0.1 Nm/A, preferably greater than or equal to 0.2 Nm/A and particularly preferably greater than or equal to 0.3 Nm/A. This configuration enables a compact design of the gear and small transmission ratios, while still enabling the door to be closed reliably. In this way, the drive device can also be of compact construction overall.

In particular, the electric machine configured as an axial flux machine can have a ratio between the extent of at least one stator tooth in the axial direction of the electric machine as a dividend and the extent of the stator base in the axial direction of the electric machine, with the ratio being greater than or equal to 2, in particular greater than or equal to 3, in particular greater than or equal to 4, in particular greater than or equal to 5, in particular greater than or equal to 6.

It may be preferred that the stator comprises the stator base, which has an, in particular plate-shaped, base section and a plurality of stator teeth protruding from a common surface of the base section, in particular in the axial direction of the electric machine. It may also be preferred that at least one coil is wound directly or indirectly around at least one, in particular each, stator tooth. In particular, at least one, in particular each, stator tooth can be connected to the stator base in a form-fitting and/or force-fitting and/or materially-bonded manner or be formed in one piece with the stator base. In this way, the magnetic flux can be optimized.

It may be preferred that at least one of the stator teeth, in particular each stator tooth, has an, in particular electrically insulating, tooth cover, with the stator having a plurality of coils and at least one of the coils, in particular each coil, being wound around the tooth cover. In particular, a plurality of coils can be wound around one of the stator teeth and/or around one of the tooth covers.

In particular, the tooth cover can be electrically insulating, preferably comprising at least partially of a plastic, particularly preferably be designed as an injection-molded component.

In particular, the stator can have the, in particular plate-shaped, stator base and a bearing mount for receiving a roller bearing or a slide bearing. In particular, a roller bearing or a slide bearing can be received in or on the bearing mount. The roller bearing or the slide bearing can thereby pass through a bearing breakthrough of a circuit board of the drive device. In particular, the circuit board can be arranged in an installation space between the stator base and the rotor.

In particular, the bearing mount can be connected to the stator base in a form-fitting and/or force-fitting and/or materially-bonded manner or be formed in one piece with the stator base.

In particular, the bearing mount can be arranged on a stationary bolt which is connected to the stator in a form-fitting and/or force-fitting and/or materially-bonded manner or is formed in one piece therewith.

In particular, the tooth cover can have one or a plurality of projections, which engage into one or a plurality of recesses of a circuit board and/or of the stator tooth and/or of the stator base, in particular by means of at least one press-fit connection.

In particular, the tooth cover can be connected to the circuit board and/or the stator tooth and/or the stator base in a form-fitting and/or force-fitting and/or materially-bonded manner so as to be detachable, preferably by means of a clip connection and/or an insulation displacement connection, or so as to be non-detachable, preferably by means of ultrasonic riveting and/or by means of thermal riveting.

This configuration results in a unit of coils and the circuit board and/or the stator base and/or the stator tooth, which is easy to assemble.

It may be preferred that the stator comprises the stator base, with the stator base having the bearing mount for receiving the roller bearing or the slide bearing. It may also be preferred that the drive device comprises the slide bearing or the roller bearing for rotatably bearing the rotor with respect to the stator, with the slide bearing or the roller bearing being received in or on the bearing mount of the stator base.

In particular, the bearing mount can have an, in particular annular, bearing support surface, which is connected to the stator base in a form-fitting and/or force-fitting and/or materially-bonded manner or is formed in one piece therewith.

The bearing support surface designates a surface on or against which the bearing can rest. In particular, the bearing mount can be cylindrical, in particular hollow-cylindrical.

In particular, the stator can have a stationary bolt, with the bolt being connected to the stator in a form-fitting and/or force-fitting and/or materially-bonded manner or being formed in one piece therewith and comprising the bearing mount.

In particular, the stator can be designed as a sintered body or cast part. In particular, the stator can also be milled after sintering or casting.

In particular, the stator can be formed from a powdered, in particular magnetically optimized, material. In particular, each powder grain can be provided with an insulating coating. In particular, the stator can be made from a material that suppresses the eddy currents, preferably from pressed iron powder. In particular, the individual iron powder grains can be provided with an electrically insulating coating. In particular, the stator can be made from a thin metal sheet.

In particular, the metal sheet can be wound up as a spiral. In particular, the stator can contain nickel and/or cobalt. In particular, the stator can be made of magnetic iron with nickel portions and/or cobalt portions. Considered individually or in a suitable combination, these configurations are advantageous in terms of at least the reduction of eddy currents.

In particular, the stator can have a plurality of coils which are wound, in particular in each case, directly or indirectly around the stator teeth.

It may be preferred that the drive device has the circuit board and the stator has one or a plurality of coils, with the coils being electrically connected to the circuit board.

Within the meaning of the disclosure, a circuit board is a plate-shaped, in particular fitted, element for conducting electrical energy. The circuit board can be designed as a printed circuit board. The terms are used synonymously below. The circuit board can comprise a plurality of layers and/or have plastic and/or be designed to be flexible. In particular, the circuit board can be designed as a solid aluminum printed circuit board. This configuration is advantageous in terms of good heat conduction properties.

In particular, at least one, in particular each, coil, can be integrated in or on the circuit board, in particular arranged in the material of the circuit board.

In particular, the electric machine configured as an axial flux machine can have a circuit board which is arranged in an installation space between the stator base and the rotor, with at least one, in particular each, coil being electrically connected to the circuit board.

In particular, the coil can be soldered to the circuit board. In particular, the printed circuit board can extend at least partially over an installation space that is delimited by a lateral surface of the stator that is extended in the axial direction of the electric machine and/or by a lateral surface of the rotor that is extended in the axial direction of the electric machine.

In particular, the circuit board can be arranged parallel to the stator base.

In particular, the stator can have the, in particular plate-shaped, stator base and a plurality of stator teeth protruding from the stator base in the axial direction of the machine, with the circuit board being arranged in a first plane, in particular parallel to the stator base, with the first plane lying in an intermediate space between the stator teeth and the rotor. In particular, the circuit board can rest on the stator teeth. In particular, the circuit board can be arranged in an air gap between the stator and the rotor.

In particular, the stator can have a plurality of stator teeth protruding from the stator base in the axial direction of the electric machine, with the circuit board being arranged in a second plane, in particular parallel to the stator base, with the second plane being interrupted by at least one, in particular each stator tooth, of the stator.

This configuration is advantageous in terms of further savings of installation space in the axial direction.

In particular, the circuit board can have one or a plurality of breakthroughs, in particular the number of breakthroughs corresponding to the number of stator teeth, through which breakthroughs the stator teeth pass. In particular, the shape of the respective breakthroughs can correspond to the surface of the respective teeth parallel to the circuit board. In particular, the circuit board can comprise a single breakthrough for a plurality of or all the teeth.

It may be preferred that the drive device has a gear coupled to the electric machine. It may also be preferred that the gear is designed as a toothed gear, particularly preferably as a multi-stage spur gear and/or as a planetary gear or as an eccentric gear.

In particular, the gear can comprise any type of gear or gear combination, in particular toothed gears and/or friction gears and/or belt gears and/or cable gears and/or chain gears.

As a planetary gear, the gear can have a sun gear that is rotationally-fixed with the rotor, in particular in one piece therewith, a plurality of planetary gears fastened about the sun gear on a planetary carrier, and a ring gear that is engaged with the planets. In this case, the ring gear can be rotatably mounted and form the power output of the planetary gear, with the planetary carrier being designed to be stationary. Alternatively, the planetary carrier can be rotatably mounted and form the power output of the planetary gear, with the ring gear being designed to be stationary. The terms planet and planetary wheel are used synonymously.

As a planetary gear, the gear can also have at least one Wolfrom stage. In a preferred embodiment of such a Wolfrom stage, the planetary gear has a first gear stage and a second gear stage, with the first gear stage comprising a sun gear, a plurality of first planets fastened to a planetary carrier and driven by the sun gear, and a first stationary ring gear, and the second gear stage comprising a second rotatable ring gear, second planets which are rotationally-fixed with the first planets, in particular in one piece therewith, with the second planets driving the second ring gear. In particular, the second ring gear can form the power output of the planetary gear.

In particular, the gear can be designed as a combination of planetary gear and spur gear. The ring gear of the planetary gear can have external teeth and act as a spur gear. In particular, the ring gear can be engaged with a closer wheel of a closer module and/or an interface element, and/or the ring gear can form the interface element.

In the case of the eccentric gear, it can be designed as a planetary eccentric gear and/or as a strain wave gear.

It may be preferred that at least one first gear element of the gear is arranged coaxially to the electric machine. It may also be preferred that the rotor is connected in a rotationally-fixed manner to the first gear element of the gear, in particular to a sun gear of the gear designed as a planetary gear.

It may be preferred that the gear has a first gear element, which is connected to the rotor in a rotationally-fixed manner, and a second gear element, with the second gear element being operatively connected, in particular being engaged, with the first gear element. It may also be preferred that an axis of rotation of the second gear element runs in an installation space between the machine axis and an outer lateral surface of the rotor that is extended virtually in the axial direction of the machine, in particular parallel to the machine axis.

It may also be preferred that the rotor is connected in a rotationally-fixed manner to a lever to form a connection of the drive device to the leaf or to a frame.

A gear-free drive device is advantageous in this configuration, since the torque can be transmitted from the electric machine via the lever, in particular a linkage, in particular a scissor linkage, to the leaf or the frame.

In particular, the drive device can be mounted either on the frame or on the leaf. Within the meaning of the disclosure, the term frame also includes a door frame or window frame. In particular, the lever can be designed in such manner that a voltage supply of the electric machine and/or at least one control signal for the electric machine can be transmitted via the lever to the electric machine.

It may be preferred that the drive device has a closer module with at least one mechanical energy storage device and at least one transmission element for translating a linear movement of the energy storage device into a rotational movement of the transmission element. It may also be preferred that the drive device has the drive module with a drive housing, with the axial flux machine and/or a gear coupled to the axial flux machine being arranged in the drive housing.

In particular, the mechanical energy storage device can comprise one or a plurality of compression springs and/or tension springs, which are connected via a linkage carriage to the transmission element for translating the linear movement of the energy storage device into a rotational movement of the transmission element. The transmission element can be designed symmetrically or asymmetrically, in particular as a heart-shaped stroke-producing cam disc.

In particular, the closer module can have a closer housing. In particular, the transmission element and/or a closer wheel can be arranged within the closer housing. The wording—within the housing—means that the elements are arranged at least partially, in particular completely, in the space formed by the housing. In particular, an operative connection can be formed between the rotor and the energy storage device.

This configuration is advantageous in terms of the modularity of the drive device, i.e. of the respective modules and/or elements that can be used and can be usable separately from one another.

In particular, an output axis of an output shaft and the axis of rotation of the transmission element can run parallel to one another. On the one hand, as a result, the output shaft and the transmission element do not rotate about the same axis of rotation and can be arranged in different positions, in particular in a modular manner. On the other hand, the parallel profile reduces energy losses and facilitates assembly.

In particular, the drive device can have an interface element for forming an operative connection between the rotor and the energy storage device. In particular, the drive housing can comprise a first opening and the closer housing can comprise a second opening. In particular, the drive housing and the closer housing can be arranged relative to one another in such manner that the energy storage device and the rotor are in operative connection with one another through the first and the second opening by means of the interface element.

In particular, the interface element can be designed as at least one gear wheel. In particular, the interface element can have a plurality of gear wheels.

In particular, the interface element can protrude into the drive housing and/or the closer housing. In particular, the interface element can be designed as at least one gear element of the gear. In particular, the interface element can be designed as a closer wheel, in particular a closer gear wheel. In particular, the closer wheel can be connected in a rotationally-fixed manner to the transmission element, in particular in a form-fitting and/or force-fitting and/or materially-bonded manner

or be formed in one piece therewith.

In particular, the drive module and/or the closer module can be arranged at least partially, in particular completely, within a superordinate housing. In particular, the drive housing can be connected to the superordinate housing in a form-fitting and/or force-fitting and/or materially-bonded manner. In particular, the closer housing can be connected to the superordinate housing in a form-fitting and/or force-fitting and/or materially-bonded manner. In particular, one or a plurality of such connections can be designed in the form of at least one screw connection and/or one pin connection and/or one press fit and/or one T-groove and/or one snap connection. In particular, the drive housing can be connected to the closer housing in a form-fitting and/or force-fitting and/or materially-bonded manner, preferably by means of at least one screw connection and/or one pin connection and/or one press fit and/or one T-groove and/or one snap connection.

In particular, the drive device can have a control module with a control device. In particular, the control module can be arranged at least partially, in particular completely, within the superordinate housing of the drive device.

In particular, the control module can be arranged on the closer module or within the drive housing.

In particular, the control module can comprise a control housing. In particular, the control module can be arranged entirely within the control housing. In particular, the control housing can be connected to the superordinate housing and/or to the drive housing and/or to the closer housing in a form-fitting and/or force-fitting and/or materially-bonded manner. In particular, one or a plurality of such connections can be designed in the form of at least one screw connection and/or one pin connection and/or one press fit and/or one T-groove and/or one snap connection.

In particular, the drive housing can have one or a plurality of prefabricated mounting points for the form-fitting and/or force-fitting and/or materially-bonded connection with the electric machine and/or the gear and/or the output shaft. In particular, the closer housing can have one or a plurality of prefabricated mount points for the form-fitting and/or force-fitting and/or materially-bonded connection with the closer wheel and/or the transmission element and/or the axle body and/or the linkage carriage.

This configuration is advantageous with regard to a simple and easy-to-assemble design.

It may be preferred that the drive device has the gear coupled to the axial flux machine, with the gear having a transmission ratio as a quotient of the speed of the rotor as a dividend and the speed of the transmission element, which is less than 125, preferably less than 100, particularly preferably is less than 75.

It may be preferred that the drive device is used in a swing leaf drive and/or in a sliding door drive and/or in a revolving door drive.

In a swing leaf drive, a leaf is pivoted from a closed position, in which the leaf rests against a frame, to an open position about a leaf axis by means of the drive device, with the torque being transferred by means of a lever from the output shaft of the drive device to the door or to the frame. The drive device can be mounted on the leaf, and a slide rail can be arranged on the frame, or can be mounted on the frame, and a slide rail can be arranged on the leaf. In addition to the drive device, the swing leaf drive can also comprise the lever and/or the slide rail and/or the leaf. In particular when used on fire protection leaves, the drive device can have a closer module. In the event of a fire, the closer module ensures that the fire protection leaf closes, in particular without manual actuation.

In a sliding door drive, a leaf is displaced in a translatory manner along a slide rail by means of the drive device, with it being possible for the leaf to be connected to a linkage carriage running in the slide rail. In addition to the drive device, the sliding door drive can have the leaf and/or the slide rail and/or the linkage carriage.

In a revolving door drive, two or more door leaves, which are attached to a vertical central axis and rotate in a round rotary housing, are rotated by means of the drive device. In addition to the drive device, the revolving door drive can have the rotary housing and/or the leaves.

In another aspect of the disclosure, a method for moving a leaf, in particular a door leaf or a window leaf, can preferably be indicated, with the movement of the leaf being at least supported by a drive device with at least one electric machine, with the electric machine being designed as an axial flux machine.

In particular, the drive device, preferably the electric machine and/or the gear and/or the energy storage device, can be designed in such manner that the leaf can be moved without manual force exerted by a person, in particular without a manual torque exerted by a person, on the leaf, in particular in a fully automated manner, by means of the drive device, in particular by means of a machine torque. However, the movement of the leaf can be accelerated by the manual force exerted by the person, in particular the manual torque, on the leaf.

The movement of the leaf here means an opening movement and/or a closing movement of the leaf.

Alternatively, the drive device, preferably the electric machine and/or the gear and/or the energy storage device, can be designed as an auxiliary drive in such manner that the leaf is only moved if at least at one point in time of the movement of the leaf, in particular at a beginning of the movement, in addition to a force generated by the drive device, in particular a machine torque, a manual force exerted by a person, in particular a manual torque exerted by a person, is exerted on the leaf.

### BRIEF DESCRIPTION OF THE DRAWINGS

Further details and advantages of the disclosure will be explained below on the basis of the exemplary embodiments shown in the figures. They show:

FIG. 1 an exemplary embodiment of a drive device according to the disclosure in a schematic sectional representation;

FIG. 2 the drive device from FIG. 1 as a detail in a perspective view;

FIG. 3 a transmission element as a detail in a top view,

FIG. 4 a further exemplary embodiment of a drive device with a planetary gear,

FIG. 5 the drive device from FIG. 4 with the revolving wheel removed,

FIG. 6 an axial flux machine in a basic representation in section,

FIG. 7 a stator of the axial flux machine from FIG. 6 as a detail,

FIG. 8 a circuit board as a detail in top view of a first end face, and

FIG. 9 the circuit board from FIG. 8 in top view of an end face opposite the first end face.

### DETAILED DESCRIPTION OF THE DRAWINGS

The same parts are always provided with the same reference numerals in the different figures, which is why they are generally also only described once.

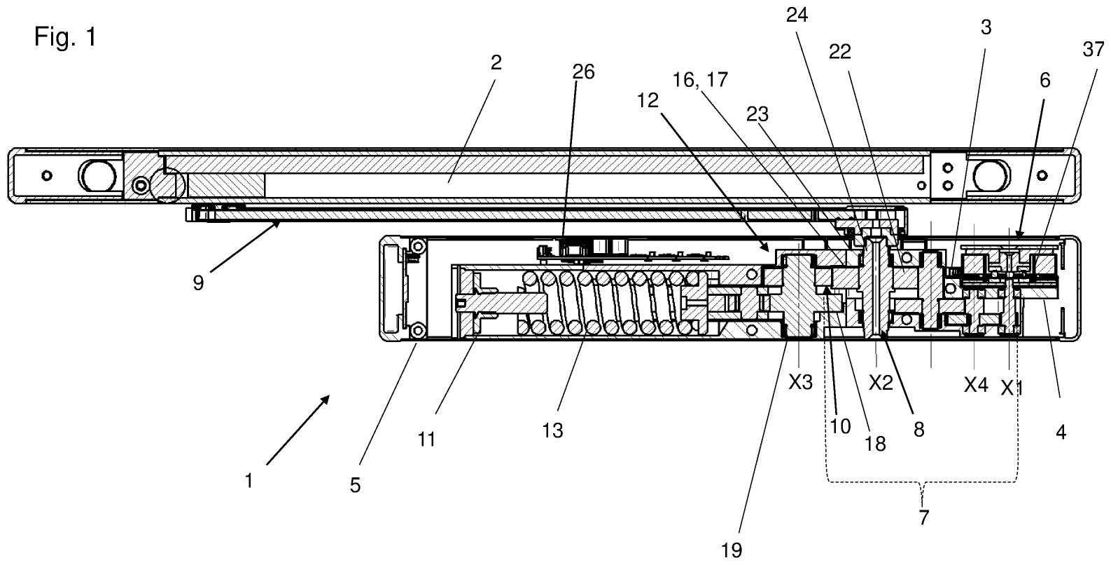

FIG. 1 shows a drive device 1 for moving a leaf. The drive device 1 has a drive module 3. The drive module 3 has a drive housing 4, an electric machine 6 with a machine axis X1, and a gear 7 with an output shaft 8 mounted so as to be rotatable about an output axis X2 for connection to a lever 9.

The drive device 1 also has a closer module 11 which has a closer housing 12 and a mechanical energy storage device 13.

The drive device 1 has an interface element for forming an operative connection between the drive module 3 and the closer module 11.

The gear 7 has a transmission ratio as a quotient of the speed of the rotor as a dividend and the speed of the output shaft, with the transmission ratio being less than 125, preferably less than 100, particularly preferably less than 75.

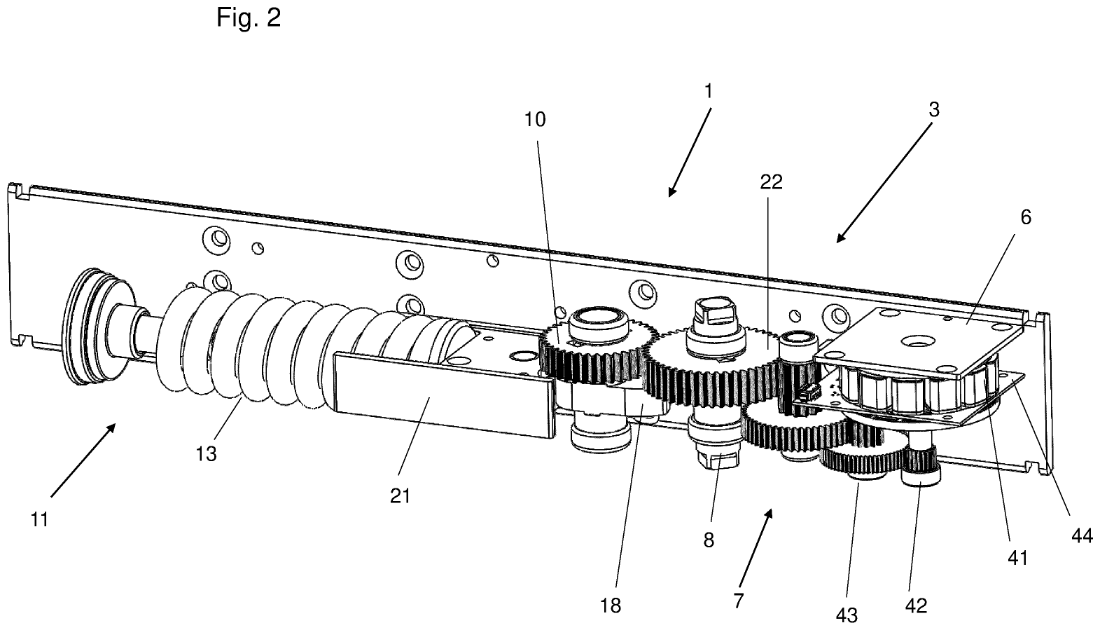

The lever 9 is used to form a connection between the drive device 1 and the leaf, i.e. with the exemplary door leaf or window leaf or with a frame, with the drive device 1 being able to be mounted either on the frame or on the leaf. Within the meaning of the disclosure, the term frame also includes a door frame or window frame. In particular, the lever 9 can be designed in such manner that a voltage supply of the electric machine 6 and/or at least one control signal for the electric machine 6 can be transmitted via the lever 9 to the drive module 3, in particular to the electric machine 6 and/or a control module 26. The lever 9 is guided in a slide rail 2, which in the exemplary embodiment represented in FIGS. 1 and 2, would be mounted on a frame, not represented there.

The drive housing 4 has a first opening 16, with the closer housing 12 having a second opening 17. As can be seen in FIG. 1, the drive housing 4 and the closer housing 12 are arranged in relation to one another in such manner that the closer module 11, in particular the energy storage device 13, and the gear 7, in particular the output shaft 8, are in operative connection with one another through the first opening 16 and the second opening 17 by means of the interface element.

The drive module 3 and/or the closer module 11 is arranged at least partially, in particular completely, within a superordinate housing 5. The drive housing 4 is connected to the superordinate housing 5 and/or to the closer housing 12 in a form-fitting and/or force-fitting and/or materially-bonded manner. The closer housing 12 is connected to the superordinate housing 5 in a form-fitting and/or force-fitting and/or materially-bonded manner. One or a plurality of such connections are designed, for example, in the form of at least one screw connection.

It can be seen in FIGS. 1 and 2 that the output axis X2 is parallel to the machine axis X1.

The closer module 11 has a transmission element 18 for translating a linear movement of the energy storage device 13 into a rotational movement of the transmission element 18 about an axis of rotation X3 of the transmission element 18. As can be seen by way of example in FIG. 1, the output axis X2 and the axis of rotation X3 of the transmission element 18 are spaced apart from one another and run parallel to one another. The transmission element 18 is designed as a cam disc, specifically as a heart-shaped stroke-producing cam disc, and is rotatably mounted in a rotationally-fixed manner with a closer wheel 10.

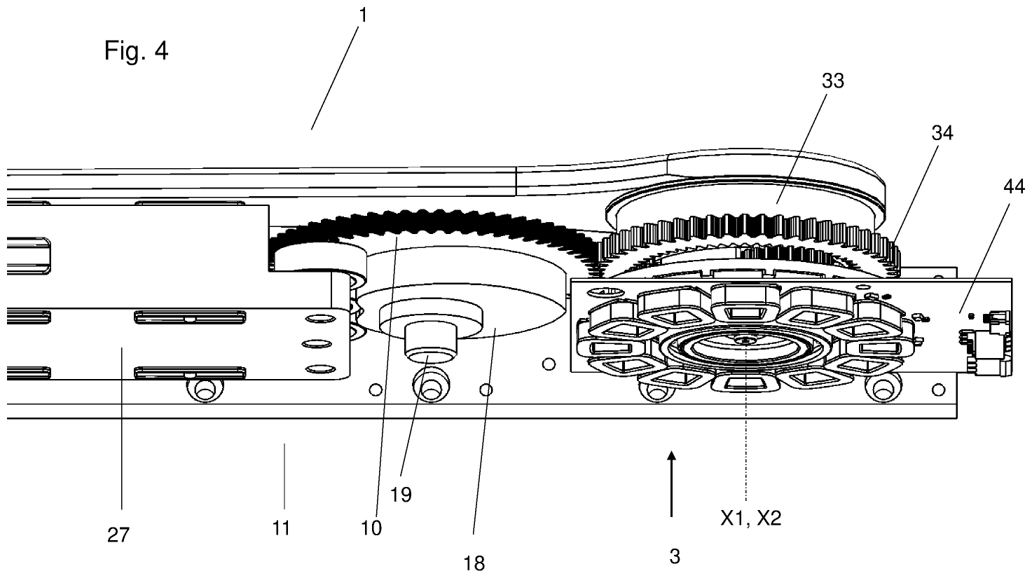

For example, the mechanical energy storage device 13 is designed as a compression spring. The compression spring is connected via a linkage carriage 27 to the transmission element 18 for translating the linear movement of the mechanical energy storage device 13 into a rotational movement of the transmission element 18. The linkage carriage 27 has sliding elements 21, which can be seen in FIG. 2. The linkage carriage 27 can be seen in FIG. 4.

The closer wheel 10 is arranged in a coaxial and rotationally-fixed manner in relation to the transmission element 18 for translating the linear movement of the energy storage device 13 into a rotational movement of the transmission element 18.

The gear 7 has an output wheel 22, namely an output gear wheel, which is coaxial and rotationally-fixed with the output shaft 8, with the output wheel 22 being engaged with the closer wheel 10.

In the exemplary embodiment of FIGS. 1 and 2, the interface element is formed by the output wheel 22.

For example, the drive housing 4 has a first wall 23 with an output opening 24 for the, in particular, rotationally-fixed connection of the output shaft 8 to the lever 9, a second wall adjoining the first wall 23 and a third wall opposite the second wall, with the drive device 1 being designed so as to be fastened both with the second wall and the third wall facing towards the leaf, i.e. the exemplary door leaf. The same can apply to the closer housing 12. The drive housing 4, but also the closer housing 12, can each be cuboid in order to enable assembly on both sides.

The control module 26, which has a control device, can also be seen in FIG. 1. The control module 26 is arranged at least partially, in particular completely, within the superordinate housing 5 of the drive device 1.

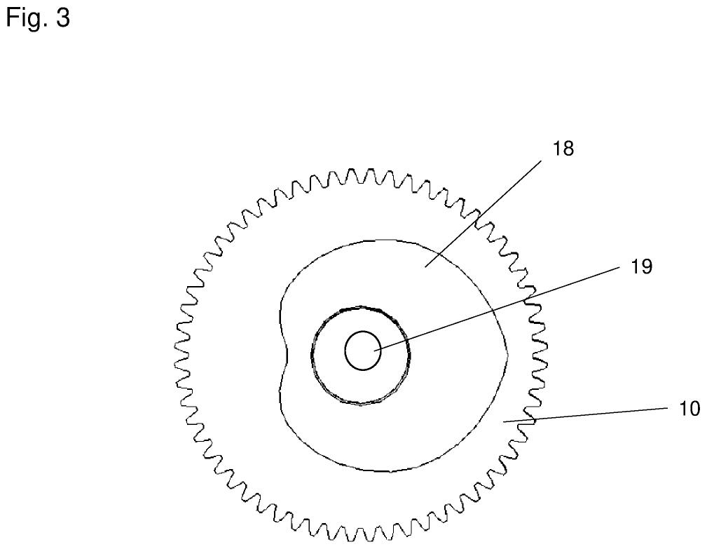

FIG. 3 shows a special embodiment, with the transmission element 18 being formed as a cam disc, specifically as a heart-shaped stroke-producing cam disc. As can also be seen in FIG. 3, a fixed axle body 19 is arranged, with the transmission element 18 and the closer wheel 10 being rotatably mounted on the axle body 19.

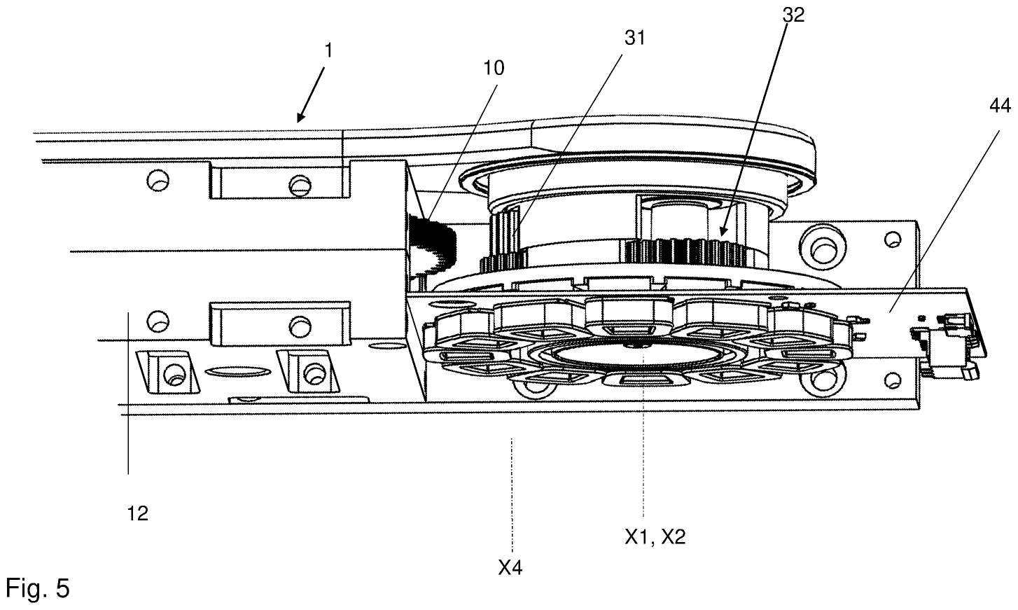

In the FIGS. 4 and 5, the drive device 1 is represented in a further configuration, with the optional gear 7, in contrast to the exemplary embodiment of FIGS. 1 and 2, being designed as a planetary gear.

As a planetary gear, the gear 7 has at least one Wolfrom stage. Such a Wolfrom stage has a first gear stage and a second gear stage. The first gear stage comprises a sun gear, a plurality of first planets 31 fastened to a planetary carrier and driven by the sun gear, and a first, stationary ring gear. The sun gear, the planetary carrier and the first stationary ring gear cannot be seen in FIGS. 4 and 5 due to the section selected. The second gear stage comprises a second rotatable ring gear 33, second planets 32 which are rotationally-fixed, in particular in one piece, with the first planets 31. The second planets 32 drive the second ring gear 33. The second ring gear 33 forms the power output of the planetary gear. In FIG. 5, the second ring gear is removed.

The gear 7 according to the exemplary embodiment of FIGS. 4 and 5 is designed as a combination of planetary gear and spur gear. The second ring gear 33 of the planetary gear has external teeth 34 and acts as a spur gear. The second ring gear 33 is engaged with the closer wheel 10 of the closer module 11. In the exemplary embodiment of FIGS. 4 and 5, the closer wheel 10 forms the interface element.

In the exemplary embodiment of FIGS. 4 and 5, the output axis X2 is coaxial with the machine axis X1.

In the exemplary embodiments described, the electric machine 6 is designed as an axial flux machine.

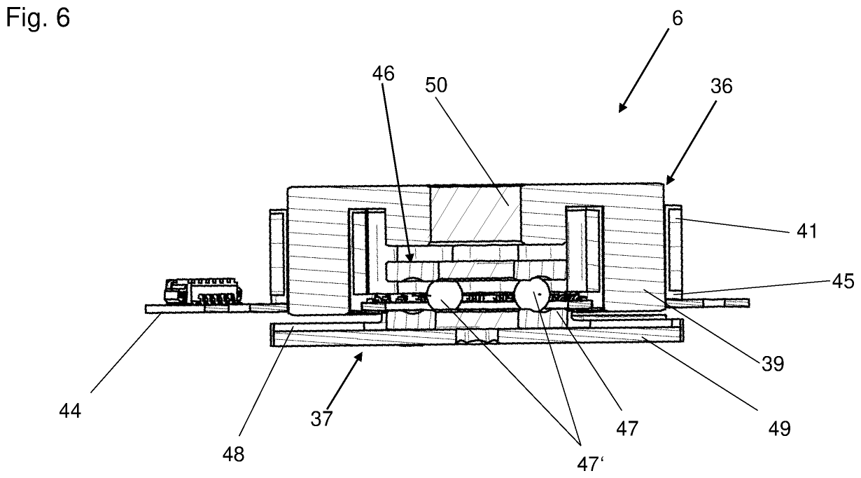

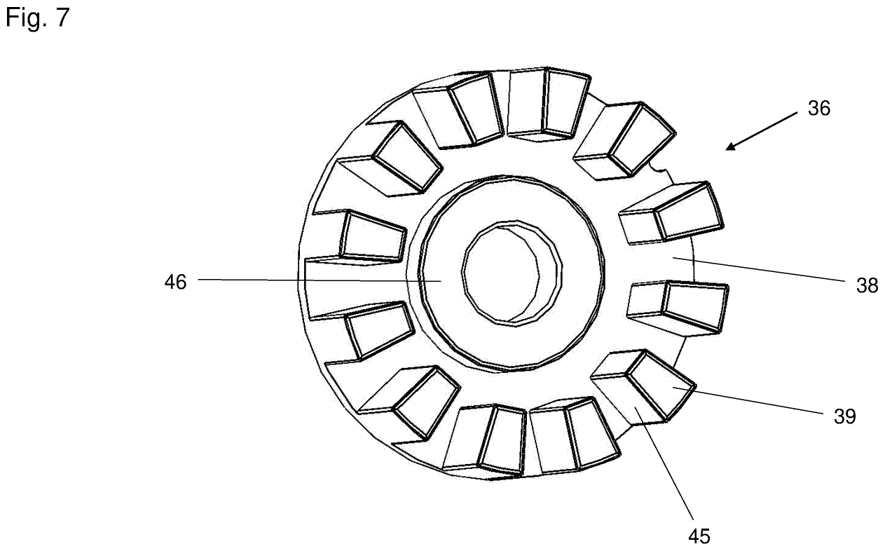

The electric machine 6 is represented in principle as a detail in FIG. 6. The electric machine 6 has a stator 36 and a rotor 37. The stator 36 is also represented as a detail in FIG. 7 and has a plate-shaped stator base 38 and a plurality of stator teeth 39 protruding from the stator base 38 in the axial direction of the electric machine 6. A coil 41 is arranged around each of the stator teeth 39. Each stator tooth 39 has an electrically insulating tooth cover 45, with the stator 36 having a plurality of coils 41 and each of the coils 41 being wound around the tooth cover 45 and therefore indirectly via the tooth cover 45 around the stator tooth 39. The stator teeth 39 pass through a circuit board 44 on which the coils 41 are contacted.

It can be seen in FIG. 6 that the stator 36 also comprises a stationary bolt 50, with the bolt 50 having a bearing mount 46 for receiving a roller bearing 47. A roller bearing 47 with balls 47′ is represented in FIG. 6 as an example. The drive device 1 comprises the roller bearing 47 for the rotatable bearing of the rotor 37 with respect to the stator 36, with the roller bearing 47 being received on the bearing mount 46 of the bolt 50. The rotor 37 is rotatably mounted on the stator 36 by means of the roller bearing 47. In an embodiment that is not represented, a bearing mount can be provided directly on the stator base, on which a roller bearing can be received.

The rotor 37 comprises a plurality of permanent magnets 48. Each permanent magnet 48 is formed in a plate shape. The rotor 37 has a rotor plate 49 in the form of a rotor disc. Furthermore, each permanent magnet 48 protrudes from the rotor plate 49 of the rotor 37 in the axial direction of the electric machine, in particular in the direction of the stator 36.

As can best be seen from FIGS. 1 and 2, the gear 7 has a first gear element 42 which can be rotated coaxially with the machine axis X1 and which is connected to the rotor 37 in a rotationally-fixed manner. The gear 7 also has a second gear element 43, which is operatively connected to the first gear element 42, with an axis of rotation X4 of the second gear element 43 running in an installation space between the machine axis X1 and an outer lateral surface of the rotor 37 that is extended virtually in the axial direction of the electric machine 6 and parallel to the machine axis X1.

In the exemplary embodiment of FIGS. 4 and 5, the first gear element 42 is formed by the sun gear, with the second gear element 43 being formed by the planet 32.

A circuit board 44, which is arranged in the installation space between the stator base 38 and the rotor 37, can also be seen in FIGS. 2 and 4 as well as 5 and 6. The circuit board 44 is arranged parallel to the stator base 38. The circuit board 44 is arranged in a second plane parallel to the stator base 38, with the second plane being interrupted by each stator tooth 39 of the stator 36.

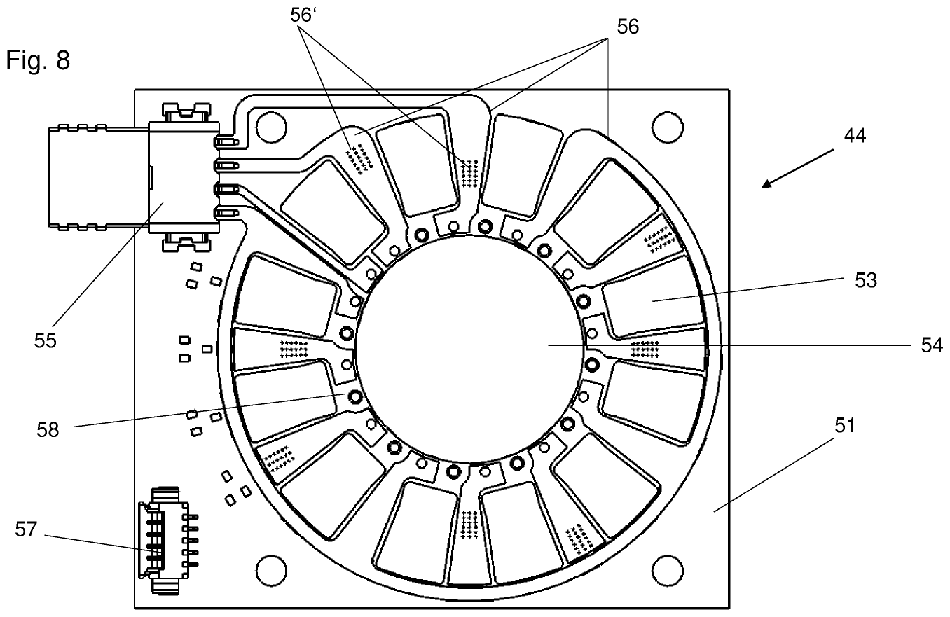

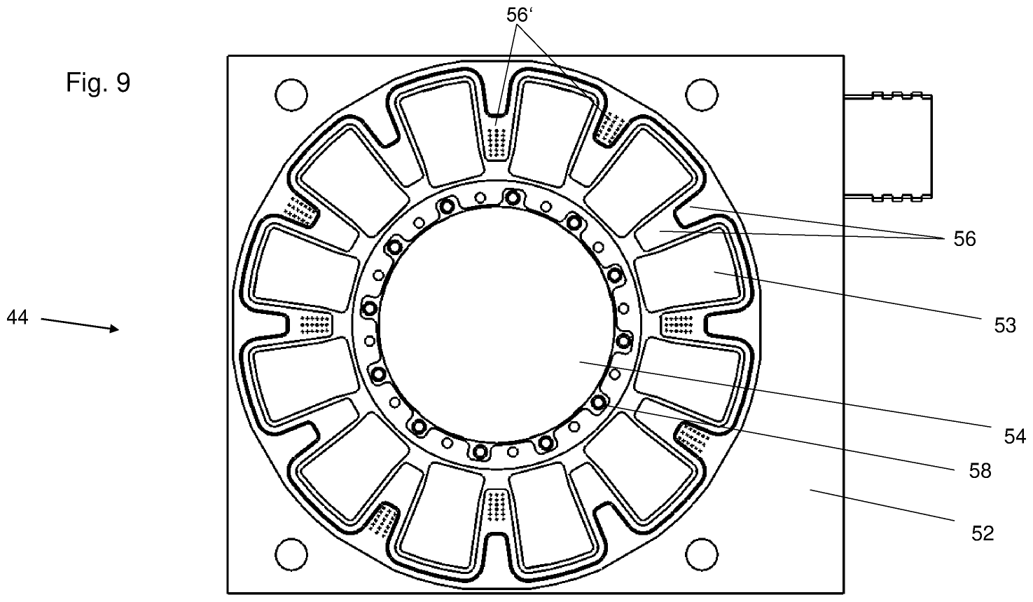

The circuit board 44 is represented as a detail in FIGS. 8 and 9. FIG. 8 shows a top view of a first end face 51 of circuit board 44. The first end face 51 is oriented in the direction of the stator 36 in the represented exemplary embodiments. FIG. 9 shows a top view of an end face 52 opposite the first end face 51.

The circuit board 44 has a number of breakthroughs 53 corresponding to the number of stator teeth 39, through which breakthroughs the stator teeth 39 pass. The breakthroughs 53 correspond to the shape of the stator teeth 39. The circuit board 44 has a bearing breakthrough 54 through which the roller bearing 47 passes. An element 55 of a control device for controlling the currents conducted through the coils 41 is arranged on the circuit board 44. Conduction paths 56 are connected to the element 55 of the control device. A bus connector 57 and contact breakthroughs 58 can also be seen. In this case, a plurality of conduction paths 56 are contacted on the first end face 51 of the circuit board 44 and a plurality of conduction paths 56 are contacted on the end face 52 opposite the first end face 51. As a result, the installation space of the circuit board is optimally utilized. The two conduction paths 56 represented on the left in the image plane of FIG. 8 are connected through by means of vias 56′ on the opposite end face 52, as can also be seen in FIG. 9.

1. A drive device for moving a leaf with an electric machine, wherein the electric machine is designed as an axial flux machine comprising a single, stator and a single, rotor, configured to be rotated about a machine axis with respect to the stator.

2. The drive device according to claim 1, wherein the stator has one or a plurality of coils, wherein the coil or coils of the stator are arranged such that a magnetic flux is generated through the coil or coils in a direction parallel to the machine axis.

3. The drive device according to claim 1, wherein the rotor comprises at least one permanent magnet, wherein the permanent magnet is arranged along a virtual circle around the machine axis and spans a first angular range, and the stator comprises a stator base with at least one stator tooth protruding from the stator base, wherein the stator tooth is arranged along a virtual circle around the machine axis and spans a second angular range, wherein the ratio of the first angular range as a dividend to the second angular range is in the range from 1.1 to 1.6.

4. The drive device according to claim 2, wherein the ratio between the number of permanent magnets as a dividend and the number of coils is in a range from 1.0 to 1.6.

5. The drive device according to claim 1, wherein the stator comprises a stator base which has a plate-shaped, base section and a plurality of stator teeth protruding from a common surface of the base section, in the axial direction of the electric machine, whereby at least one coil is wound directly or indirectly around at least one, each, stator tooth and/or in that at least one, each, stator tooth is connected to the stator base in a form-fitting and/or force-fitting and/or materially-bonded manner or is formed in one piece with the stator base.

6. The drive device according to claim 5, wherein at least one of the stator teeth has an electrically insulating, tooth cover, wherein the stator has a plurality of coils and at least one of the coils is wound around the tooth cover.

7. The drive device according to claim 1, wherein the stator comprises a stator base, wherein the stator base has a bearing mount for receiving a roller bearing or a slide bearing, wherein the drive device comprises the slide bearing or the roller bearing for rotatably bearing the rotor with respect to the stator, wherein the slide bearing or the roller bearing is received in the bearing mount of the stator base.

8. The drive device according to claim 1, wherein the drive device has a circuit board and the stator has one or a plurality of coils, wherein the coils are electrically connected to the circuit board.

9. The drive device according to claim 1, wherein the drive device has a gear coupled to the electric machine, and the gear is designed as a toothed gear.

10. The drive device according to claim 9, wherein at least one first gear element of the gear is arranged coaxially to the electric machine, and the rotor is connected in a rotationally-fixed manner to the first gear element of the gear.

11. The drive device according to claim 9, wherein the gear has a first gear element, which is connected in a rotationally-fixed manner to the rotor, and a second gear element, wherein the second gear element is operatively connected with the first gear element, wherein an axis of rotation of the second gear element runs in an installation space between the machine axis and an outer lateral surface of the rotor that is extended virtually in the axial direction of the electric machine.

12. The drive device according to claim 1, wherein the rotor is connected in a rotationally-fixed manner to a lever to form a connection of the drive device to the leaf or to a frame.

13. The drive device according to claim 1, wherein the drive device has a closer module with at least one mechanical energy storage device and at least one transmission element for translating a linear movement of the mechanical energy storage device into a rotational movement of the transmission element, wherein the drive device has a drive module with a drive housing, wherein the axial flux machine and/or a gear coupled to the axial flux machine is arranged in the drive housing.

14. The drive device according to claim 13, wherein the gear has a transmission ratio as a quotient of the speed of the rotor as a dividend and the speed of the transmission element, which is less than 125.

15. A use of a drive device according to claim 1 in a swing leaf drive or in a sliding door drive or in a revolving door drive.
